(19) United States
(12) Patent Application Publication
(10) Pub. No.: US 2003/0108191 A1
(43) Pub. Date: Jun. 12, 2003

(54) Method and system for spectrally compatible remote terminal ADSL deployment

(76) Inventor: Kenneth James Kerpez, Long Valley, NJ (US)

Correspondence Address: William A. Schoneman, Esq., Telcordia Technologies, Inc., 445 South Street 1G112R, Morristown, NJ, 07960, US

(21) Appl. No.: 10/292,987

(22) Filed: Nov. 13, 2002

Related U.S. Application Data
(60) Provisional application No. 60/350,629, filed on Nov. 13, 2001.

(51) Int. Cl. H04M 11/00; H04M 1/00

(52) U.S. Cl. 379/399.01; 379/93.01

(57) ABSTRACT

Remote terminal (RT) based ADSL is made compatible with central office (CO) based ADSL so as to maximize both the upstream and downstream data transmission rates while maintaining compliance with spectrum management guidelines. Flat power back-off (PBO) of the downstream transmit power for RT-based ADSL is combined with a notched frequency spectrum, i.e., the turning off some of the tones transmitted from RT-based ADSL. In additional a sloped power back-off (PBO) can be used alone or in combination with a notched frequency spectrum to improve data rates even more. These techniques can be used to make RT-based ADSL compatible with CO-based ADSL, at all combination of loop lengths, while still allowing the RT-based ADSL a downstream bit rate that is within the spectrum compatibility guidelines.

### RELATED APPLICATIONS

The present application claims the benefit of U.S. Provisional Application Serial No. 60/350,629 filed Nov. 13, 2001 and entitled “Method And Apparatus For Remote Terminal ADSL Deployment.”

### FIELD OF THE INVENTION

This invention is related to the deployment of asymmetrical digital subscriber line (“ADSL”) technology in the remote terminals of telephone networks and the maintenance of spectral compatibility of such remote terminal ADSL with the ADSL technology deployed in the central office of the telephone company.

### BACKGROUND

The mainstay of the telephone company local network is the local subscriber loop, i.e., the loop from a central office (“CO”) to a subscriber. The local subscriber loop is now being used to provide broadband digital telecommunication services such as digital subscriber line (“DSL”) service. Such broadband DSL services include integrated services digital subscriber network (“ISDN”), high-rate digital subscriber line (“HDSL”), asymmetrical digital subscriber lines (“ADSL”) and very high rate digital subscriber lines (“VDSL”) technology. DSL services allow residential and business customers to send and/or receive digital data at higher rates of speed than were previously possible using analog modem technology.

DSL technologies are engineered to operate over a class of subscriber loops, such as nonloaded loops (18 kft) or Carrier Serving Area (CSA) loops (9 to 12 kft). Digital Subscriber Line (DSL) technology exploits the existing, ubiquitous, copper telephone loop plant to provide megabit per second (Mbps) high-speed Internet access and other services. The great majority of residential customers and many business customers are served by such metallic (copper) twisted pair cables connected from a local switch in the central office (“CO”) to the subscriber's land-line telephones. For each subscriber, telephone and DSL signals travel on a twisted pair from a central office (CO) to the subscriber.

Asymmetric DSL (“ADSL”) is one type of DSL now standardized as T1.413 by the American National Standards Institute (“ANSI”). ADSL uses the existing copper wires from the central office of the telephone company to the subscriber's premises to provide high-speed, high-bandwidth digital data transmission service. ADSL modems exist both in the central office where they are referred to as ADSL terminal units—central office (“ATU-C”) and at the subscriber end where they are referred to as ADSL terminal units—remote (“ATU-R”). There is a third type of terminal unit, an intermediate terminal unit (“ATU-I”), which is used to provide service to one or more ATU-R downstream from a central office.

In ADSL more information can be delivered from the central office to the subscriber than in the reverse direction, thus, the asymmetric nature of the service. The original specification for ADSL provided for 1.536 Mbps downstream from the central office to the subscriber and 16 Kbps from the subscriber to the central office. Since that time additional higher speed ADSL has been developed which permit downstream operation at up to 8 Mbps or more and upstream operation at up to 1 Mbps or more.

Performance of ADSL service in both directions is subject to the condition of the physical copper plant of the network. The length of the loop from the central office to the subscriber, the wire gauge or gauges present in the loop, the presence of bridge taps and cross-coupled interference or crosstalk all affect the performance.

Crosstalk generally increases with increasing frequency, and because DSL frequencies extend into the Megahertz (“MHz”) range, crosstalk becomes the major limitation to high-speed ADSL. As time progresses it is expected that there will be many more ADSL users each demanding higher speed service. This will result in more crosstalk and higher-bandwidth services that are more vulnerable to crosstalk. Sources of crosstalk are often called “disturbers.” There are two types of crosstalk: near-end crosstalk (NEXT) and far-end crosstalk (FEXT). NEXT is more powerful than FEXT, particularly below about 1 MHz where many DSLs use overlapping spectra. If there is one crosstalker, then the received crosstalk PSD is the product of a PSD transmitted on a nearby pair times the crosstalk coupling transfer function. With multiple crosstalkers the received crosstalk PSD is the linear sum of each component.

In order to control crosstalk interference between loops (lines), spectrum management is necessary. The American National Standards Institute (ANSI) Working Group T1E1.4, being responsible for DSL standards on ISDN Basic Access, HDSL and ADSL, initiated a project in 1998 to develop relevant standards for spectrum management. ANSI Standard T1.417-2001, Spectrum Management for Loop Transmission Systems, was approved and issued in January 2001. This ANSI standard applies relatively rigid rules uniformly across the entire loop plant. These rules, however, do not provide any deployment guidelines for ADSL systems employing intermediate transmission units (“ATU-I”).

Remote terminal based ADSL, i.e., the use of ATU-I's, can lower the downstream bit rate of CO-based ADSL in the same binder primarily because of high-power far end crosstalk (“FEXT”). In a contribution to the T1E1 Working Group entitled “Performance of CO Deployed ADSL due to Crosstalk from RT Deployed ADSL” by J. Yang and D. Reilly, T1E1.4/2000-302, it was shown that many cases of RT-based ADSL crosstalk cause the bit rates of CO-based ADSL to be well below the basis bit rate targets necessary to be spectrally compatible. There are, however, a few combinations of loop lengths where RT-based ADSL is compatible with CO-based ADSL.

In “Simulations of ADSL with Crosstalk from Remotely-Deployed SDSL” by D. Veeneman, G. McAninch and G. Sherrrill, T1E1.4/2000-240 the impact of RT-based SDSL on ADSL was examined. The results showed that RT-based SDSL is compatible with ADSL provided that the RT-based SDSL transmit power is cut back by a small amount (at most 1 dB) in a few cases.

It would be desirable to have a technique that could provide for a method to make the deployment of RT-based ADSL compatible with CO-based ADSL.

Further it would be desirable to have a method that is easy to implement at a low-cost using as much of the existing equipment as possible.

Additionally, it would be desirable to implement these methods in a system that could provide operational guidelines for the various terminal units so as to maximize data transmission while remaining within the spectral compatibility guidelines.

### SUMMARY

In accordance with the present invention a method and system for deploying RT-based ADSL in a manner that is compatible with CO-based ADSL.

A novel method for deployment of RT-based ADSL to make it compatible with CO-based ADSL uses sloped power back-off (PBO) reducing the power by various amounts depending on the transmission frequency. A complementary method for deployment of RT-based ADSL that is compatible with CO-based ADSL identifies an lower and upper notch frequency between which no data is transmitted.

Both these techniques can be used in a system to make RT-based ADSL compatible with CO-based ADSL at all combinations of loop lengths, while still allowing the RT-based ADSL a downstream bit rate that is acceptable.

### BRIEF DESCRIPTION OF THE DRAWINGS

FIG. 1 depicts an ADSL subscriber loop system having a central office (CO) connected to a remote terminal (ATU-R) through an intermediate terminal (ATU-I);

FIG. 2 depicts an illustrative embodiment of a system for implementing the methods of the present invention;

FIG. 3 is a graphical depiction of the minimum flat downstream power back-offs (PBOs) that make RT-based ADSL spectrally compatible with CO-based ADSL for various values of Y and Z;

FIG. 4 is a graphical depiction of the lower notch frequency, fa, of RT-based ADSL with a passband PSD notch that is spectrally compatible with CO-based ADSL for various values of Y and Z;

FIG. 5 is a graphical depiction of the upper notch frequency, fb, of RT-based ADSL with a passband PSD notch that is spectrally compatible with CO-based ADSL for various values of Y and Z;

FIG. 6 is a graphical representation of the downstream bit rate of spectrally compatible RT-based ADSL using power back-off for various values of Y and Z.

FIG. 7 is a graphical representation of the downstream bit rate of spectrally compatible RT-based ADSL using a notched transmit PSD for various values of Y and Z.

FIG. 8 is a graphical representation of the maximum downstream bit rate of spectrally compatible RT-based ADSL using either power back-off (PBO) or a notched transmit PSD for various values of Y and Z.

FIG. 9 is a graphical representation of downstream bit rates of spectrally compatible RT-based ADSL using sloping power back-off for various values of Y and Z.

FIG. 10 is a graphical representation of the model for the ADSL roll-off used in the present invention compared to the sum of the power of DMT tones with 6% raised cosine PSD's for the case of DMT tones turned off between fa=250 kHz and fb=700 kHz.

FIG. 11 is a graphical representation of the maximum downstream bit rates for RT-based ADSL for various lengths of Y and Z using the method and system of the present invention.

FIG. 12 is a diagram depicting the flow of the data in the notched PSD method in accordance with the present invention.

FIG. 13 is a diagram depicting the flow of data in the sloped power back off method in accordance with the present invention.

### DETAILED DESCRIPTION

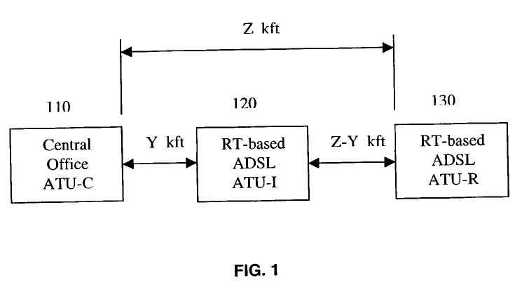

FIG. 1 depicts an ADSL system in accordance with the present invention. A central office ADSL terminal unit (ATU-C) 110 is connected to an intermediate ADSL terminal unit (ATU-I) 120 which in turn is connected to one or more subscribers through an ADSL remote terminal unit (ATU-R) 130. The connection between ATU-C 110 and ATU-I 120 and one or more ATU-Rs 130 is referred to as the local loop.

The above referenced Spectrum Management for Loop Transmission Systems provides guidelines for the proper management of spectrum so as to reduce the possibility of interference between local loops in the same binder, i.e., collocated in the same bundle of loops. ADSL bit rates are calculated with computer simulations using the methodology defined in the draft spectrum management standard referenced above which is hereby incorporated by reference. All sources of near-end crosstalk (“NEXT”) and far-end crosstalk (“FEXT”) are included by the methodology and are generated using the models of Annex L of that reference. All NEXT coupling is calculated using the following equation (1) where H(f,L) is the transfer function of the loop of length L at the frequency f (in Hz), L is the NEXT coupling length, XN=8.818×10⁻¹⁴×(n/49)⁰⁶ and n is the number of disturbers.

NEXT(F,L)=X_{N}f¹⁵(1−|H(f,L)|⁴ (4)

The simulations collocate all ATU-R's 130 and all crosstalk is in the same binder. A binder is the group of local loops held together in close proximity. All loops are 26 gauge. The distance from the central office (“CO”) ATU-C 110 to the RT-based ADSL (ATU-I) 120 is Y kft. The distance from the RT-based ADSL (ATU-I) 120 to the ATU-R 130 is Z-Y kft and the distance from the CO ATU-C 110 to the ATU-R 130 is Z kft. The RT-based ADSL (ATU-I) only transmits downstream over a distance of Z-Y kft. Reference crosstalk is CO-based and is SM1, SM2 or SM3 (as defined in the above-referenced draft spectrum management standard) according to a loop length equal to Z which is the distance from the CO to ATU-Rs. Simulations were run with crosstalk from 24 RT-based ADSLs, as well as with crosstalk from 12 RT-cased ADSLs plus 12 reference disturbers.

A known method of maximizing the downstream bit-rate of RT-based ADSL while maintaining spectral compatibility with the CO-based ADSL is the use of the flat power back-off (PBO) method. In the flat power back-off method, the downstream transmit power of RT-based ADSL is lowered (from −40 dB/Hz) to the maximum that allows the CO-based ADSL to achieve the basis target bit rate defined for distance Z in the spectrum management standard. The power back-off is the power in dB by which the transmit PSD is lowered, flat across the passband. The amount of power back-off is calculated with the crosstalk from the 24 RT-based ADSL, as well as with mixed crosstalk from 12 RT-based ADSL plus 12 reference disturbers. The maximum power back-off of the two cases was used to calculate the bit rate of RT-based ADSL. Power back-off was always greater with mixed crosstalk, except for just a few cases (Y=4 kft and Z≦6 kft) for which there was only a minor difference in power back-off. Some of the results are shown in Tables 1 and 2. In Tables 1 and 2, Y=9 kft. Table 1 depicts the calculations for the case of 24 RT-ADSL crosstalkers and Table 2 depicts the case of 12 RT-based ADSL crosstalkers and 12 CO-based reference crosstalkers.

TABLE 1

| | | | RT-based | | CO-based | Basis | | |
|---|---|---|---|---|---|---|---|---|
| | | | ADSL | RT-based | ADSL | target | CO-based | Basis |
| | | | down- | ADSL | down- | down- | ADSL | target |
| | | Power | stream | upstream | steam | stream | upstream | upstream |
| | | Back-Off | bit rate | bit rate | bit rate | bit rate | bit rate | bit rate |
| Z-Y | Z | (db) | (kbps) | (kbps) | (kbps) | (kbps) | (kbps) | (kbps) |
| 0 | 9 | 0.0 | 12488 | 1456 | 9327 | 4850 | 1456 | 645 |
| 1 | 10 | 37.1 | 8698 | 1456 | 4595 | 4595 | 1456 | 553 |
| 2 | 11 | 36.3 | 7410 | 1456 | 3598 | 3595 | 1456 | 461 |
| 3 | 12 | 36.5 | 5873 | 1456 | 2922 | 2920 | 1455 | 344 |
| 4 | 13 | 32.3 | 5377 | 1455 | 2040 | 2045 | 1440 | 202 |
| 5 | 14 | 26.3 | 5326 | 1448 | 1261 | 1265 | 1411 | 163 |
| 6 | 15 | 21.1 | 5102 | 1429 | 706 | 705 | 1360 | 124 |

The bit rate of RT-based ADSL is calculated in accordance with the draft Spectrum Management Standard, except that the downstream transmit power is lowered from −40 dBm/Hz by the power back-off. Crosstalk is from the same sources for RT-based ADSL as they are for CO-based ADSL: either 24 RT-based ADSL, or 12 RT-based ADSL plus 12 reference with the reference being CO-based. The RT-based signal and the RT-based crosstalk both have power back-off downstream. Upstream bit rates are all fairly high.

The initial set of results had downstream RT-based ADSL bit rates that were very high with high values of power back-off. In one case (Y=14 kft & Z=15 kft), there was a 7.5 Mbps downstream bit rate with 48 dB power back-off. Once the background noise was adjusted from −140 dBm/Hz to −130 dBm/Hz the rate dropped to a more reasonable 6 Mbps. All RT-based ADSL bit rates in Tables 1 and 2 were calculated with −130 dBm/Hz background noise and all CO-based ADSL bit rates were calculated with −140 dBm/Hz background noise.

TABLE 2

| | | | RT-based | | CO-based | Basis | | |
|---|---|---|---|---|---|---|---|---|
| | | | ADSL | RT-based | ADSL | target | CO-based | Basis |
| | | | down- | ADSL | down- | down- | ADSL | target |
| | | Power | stream | upstream | steam | stream | upstream | upstream |
| | | Back-Off | bit rate | bit rate | bit rate | bit rate | bit rate | bit rate |
| Z-Y | Z | (db) | (kbps) | (kbps) | (kbps) | (kbps) | (kbps) | (kbps) |
| 0 | 9 | 0.0 | 12488 | 1456 | 5644 | 4850 | 705 | 645 |
| 1 | 10 | 40.2 | 7765 | 1456 | 4595 | 4595 | 624 | 553 |
| 2 | 11 | 42.6 | 5449 | 1425 | 3596 | 3595 | 522 | 461 |
| 3 | 12 | 40.1 | 4850 | 1417 | 2920 | 2920 | 554 | 344 |
| 4 | 13 | 40.5 | 2970 | 1351 | 2045 | 2045 | 453 | 202 |
| 5 | 14 | 33.8 | 3115 | 1264 | 1266 | 1265 | 343 | 163 |
| 6 | 15 | 34.3 | 1526 | 1171 | 705 | 705 | 207 | 124 |

One of the novel spectral compatibility methods of the present invention can be used alone or in combination with a power back-off method. This method identifies a first lower notch frequency, fa (kHz), and second upper notch frequency, fb (kHz), in between which the intermediate frequencies are no longer used for transmitting data downstream from the RT-based ADSL. Only frequencies above and below the notch defined by the first and second frequencies transmit data. The notch generally slopes from first frequency fa at −200 dB/decade to a bottom where the slope meets the line from second frequency fb sloping at +200 dB/decade. Other slopes may also be used as discussed below.

In some cases the upper passband frequencies were not useful, so if the upper notch frequency fb was calculated to be 1 MHz or greater, then fb was set equal to 100,000 k Hz, essentially equal to infinity. In this specific case, the “notch” degenerates into simply estimating a high frequency portion of the transmit spectrum. Similarly, if lower notch frequency fa is less than 138 kHz then the notch simply eliminates some low frequencies. Simulations showed that simultaneously applying some power back-off improved results, so all notched RT-based ADSL were simulated with a fixed level of 4 dB power back-off in the downstream passband. The RT-based ADSL downstream passband transmit power was −44 dBm/Hz. Crosstalk was generated by the downstream SM9 PSD lowered by 4 dB and with the passband PSD notch. For a given value of lower notch frequency fa the minimum value of upper notch frequency fb was found for which the RT-based ADSL was spectrally compatible with the CO-based basis ADSL. Then the downstream bit rate of the RT-based ADSL was calculated with the same crosstalk, but with −130 dBm/Hz background noise. Both the transmit PSD and the crosstalk of downstream RT-based ADSL have the same passband notch. Only frequencies below the lower notch frequency fa or above the upper notch frequency fb can carry data.

The method of the present invention calculates the values of lower notch frequency fa in steps of 25 kHz in order to find the value of fa that maximizes the downstream bit rate of RT-based ADSL for that specific distance. For one use of the method in a simulation the values are presented in Tables 3 and 4. Table 3 sets forth the values for the case of 24 RT-based crosstalkers. Table 4 sets forth the values for the case of 12 RT-based crosstalkers plus 12 CO-based reference disturbers. In both cases Y=9 kft and the minimum RT-based downstream bit rate is presented. RT-based ADSL bit rates were almost always lower with mixed crosstalk, except for a few cases (Y=4 kft and Z<6 kft, or Y=5 kft and Z=6 kft) for which there was only a minor difference in bit rate. Upstream bit rates were all fairly high.

TABLE 3

| | | | | RT-based | | CO-based | Basis | | |
|---|---|---|---|---|---|---|---|---|---|
| | | | | ADSL | RT-based | ADSL | target | CO-based | Basis |
| | | | | down- | ADSL | down- | down- | ADSL | target |
| | | | | stream | upstream | steam | stream | upstream | upstream |
| | | fa | fb | bit rate | bit rate | bit rate | bit rate | bit rate | bit rate |
| Z-Y | Z | (kHz) | (kHz) | (kbps) | (kbps) | (kbps) | (kbps) | (kbps) | (kbps) |
| 0 | 9 | no | no | 11200 | 1456 | 9327 | 4850 | 1456 | 645 |
| | | notch | notch | | | | | | |
| 1 | 10 | 175 | 905 | 2277 | 1456 | 4595 | 4595 | 1456 | 553 |
| 2 | 11 | 175 | 831 | 2692 | 1445 | 3595 | 3595 | 1441 | 461 |
| 3 | 12 | 175 | 819 | 2616 | 1403 | 2935 | 2920 | 1393 | 344 |
| 4 | 13 | 175 | 675 | 3640 | 1341 | 2060 | 2045 | 1326 | 202 |
| 5 | 14 | 175 | 520 | 4752 | 1265 | 1266 | 1265 | 1245 | 163 |
| 6 | 15 | 200 | 438 | 5420 | 1177 | 706 | 705 | 1153 | 124 |

TABLE 4

| | | | | RT-based | | CO-based | Basis | | |
|---|---|---|---|---|---|---|---|---|---|
| | | | | ADSL | RT-based | ADSL | target | CO-based | Basis |
| | | | | down- | ADSL | down- | down- | ADSL | target |
| | | | | stream | upstream | steam | stream | upstream | upstream |
| | | fa | fb | bit rate | bit rate | bit rate | bit rate | bit rate | bit rate |
| Z-Y | Z | (kHz) | (kHz) | (kbps) | (kbps) | (kbps) | (kbps) | (kbps) | (kbps) |
| 0 | 9 | no | no | 11200 | 1456 | 5644 | 4850 | 705 | 645 |
| | | notch | notch | | | | | | |
| 1 | 10 | 300 | 100000 | 2066 | 1456 | 4601 | 4595 | 624 | 553 |
| 2 | 11 | 225 | 100000 | 1031 | 1416 | 3616 | 3595 | 522 | 461 |
| 3 | 12 | 150 | 979 | 1125 | 1384 | 2920 | 2920 | 554 | 344 |
| 4 | 13 | 150 | 902 | 1692 | 1287 | 2045 | 2045 | 453 | 202 |
| 5 | 14 | 150 | 709 | 3161 | 1187 | 1267 | 1265 | 343 | 163 |
| 6 | 15 | 150 | 625 | 3598 | 1085 | 707 | 705 | 207 | 124 |

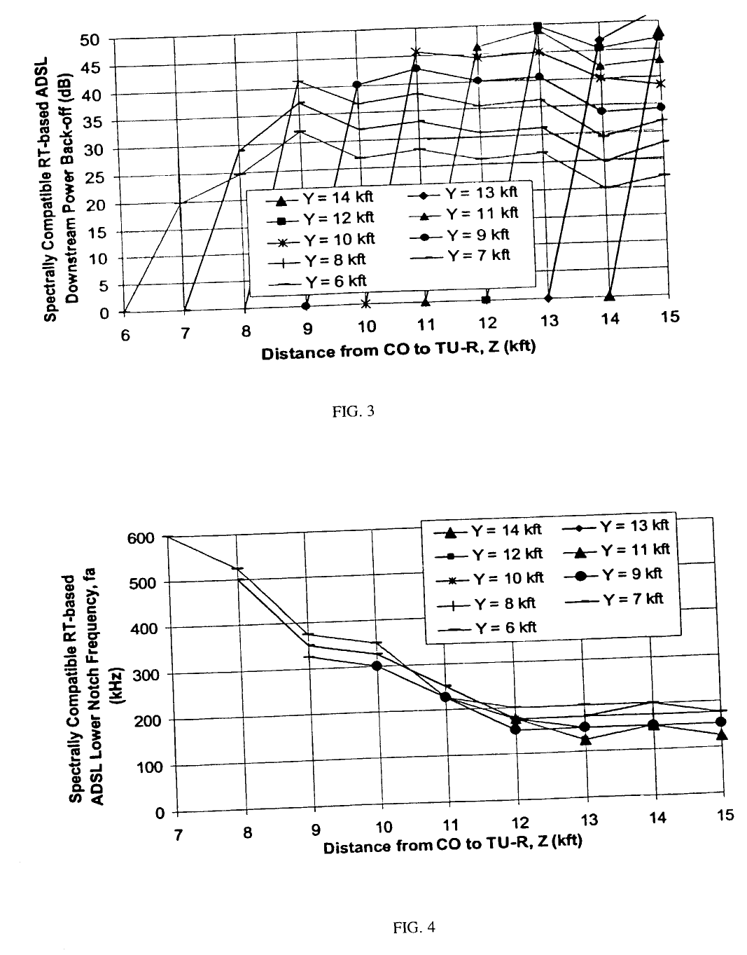

FIG. 3 depicts the minimum flat downstream power back off that makes RT-based ADSL spectrally compatible with CO-based ADSL. Y is the loop length from the CO to the RT.

FIG. 4 depicts the lower notch frequency, fa, of RT-based ADSL with a passband PSD notch that is spectrally compatible with CO-based ADSL. Y is the loop length from the CO to the RT. Some curves overlap at large Y and Z.

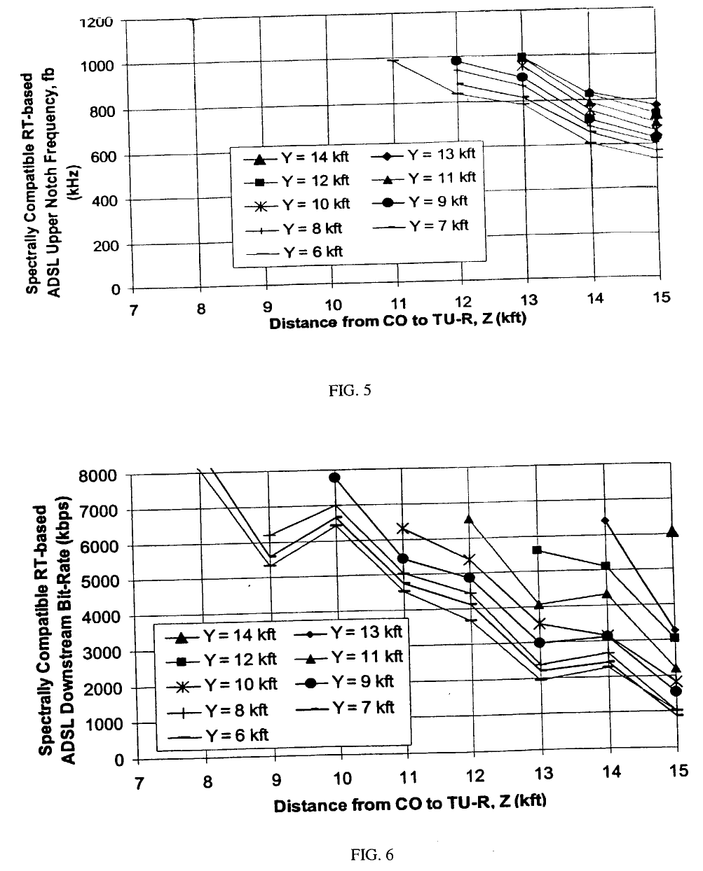

FIG. 5 depicts the upper notch frequency, fb, of RT-based ADSL with a passband PSD notch that is spectrally compatible with CO-based ADSL. Cases of RT-based ADSL with a passband PSD notch that do not use the upper passband have fb essentially equal to infinity. Y is the loop length from the CO to the RT.

FIG. 6 is the downstream bit rate of spectrally compatible RT-based ADSL using power back-off. Y is the loop length from the CO to the RT.

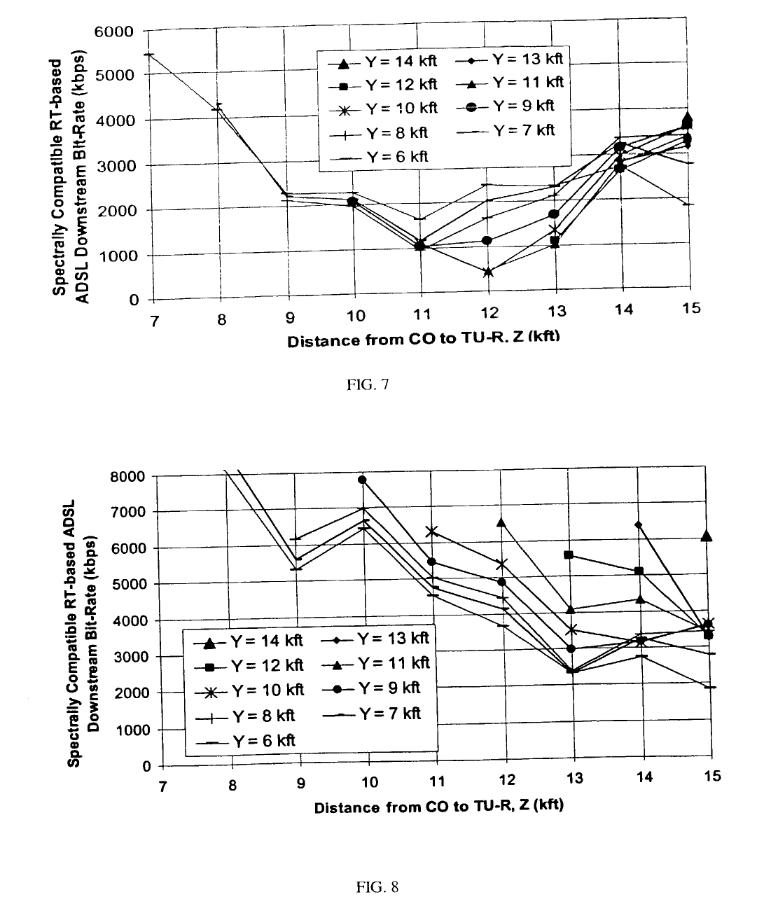

FIG. 7 is the downstream bit rate of spectrally compatible RT-based ADSL using a notched transmit PSD. Y is the loop length from the CO to the RT. The results in FIG. 6 do not appear to be very good. For some of the longer loop lengths, however, the notched PSD allows significantly higher downstream RT-based ADSL bit rates than power back-off. Combining the maximum over both methods, the best achievable downstream bit rates of spectrally compatible RT-based ADSL using this combination are shown in FIG. 8.

FIG. 8 depicts the maximum downstream bit rates for spectrally compatible RT-based ADSL using either power back-off or a notched transmit PSD. Y is the loop length from the CO to the RT. Bit rates of the spectrally compatible RT-based ADSLs in FIG. 8 can be as low as about 2 Mbps, but are typically between 3 and 6 Mbps. This is quite acceptable considering that spectral compatibility is achieved. Upstream bit rates were all fairly high.

An additional method in accordance with the present invention is an improvement over the power back-off method that uses a power back-off that is a function of the frequency across the downstream RT-based ADSL band. This can then be used alone or in combination with the PSD notch described above.

A power back-off (“PBO”) that varies as a function of frequency was tested. PBO in dB is a straight line in the frequency domain. Sloping from PBOa dB at 138 kHz to PBOb at 1104 kHz in accordance with equation (2) wherein m=(PBOb/PBOa)1104000-13800), b=PBOa−m*138000 and f is the frequency in Hz.

PBO=m*f+bdB

The bit rate of RT-based ADSL is calculated in accordance with the Spectral Compatibility Guidelines except that the downstream transmit power is lowered from the SM9 PSD template by the sloping PBO. Crosstalk is from the same sources for the RT-based ADSL as they are for the CO-based ADSL: either 24 RT-based ADSL or 12 RT-based ADSL plus 12 CO-based reference. The RT-based signal and the RT-based crosstalk both have power back-off downstream only.

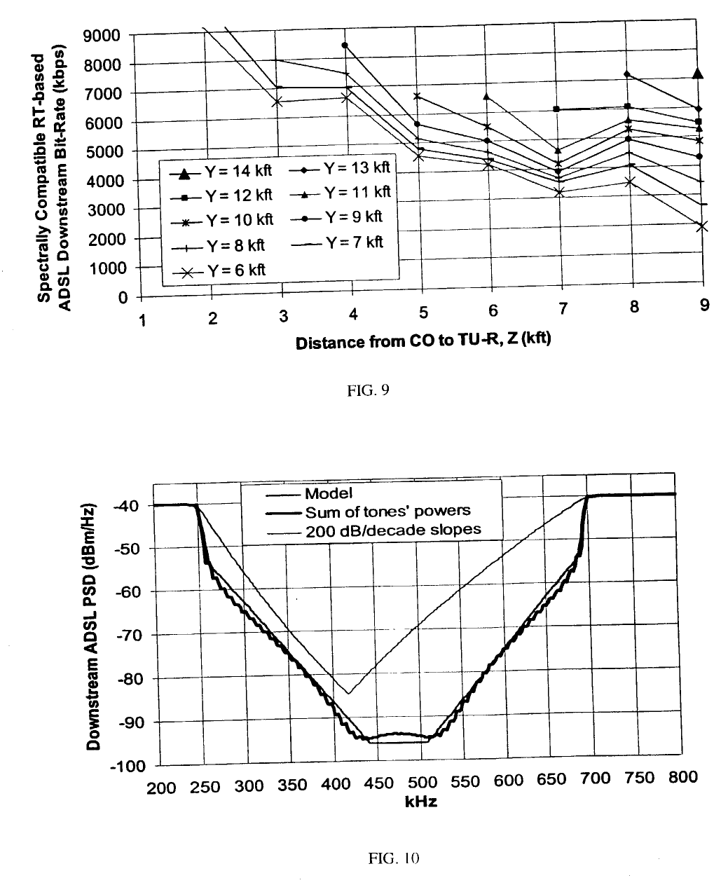

The method requires a looping through of the values of PBOa from 0 to 60 db in steps of 1 db in order to find the minimum value of PBOb that achieved spectral compatibility with the CO-based ADSL with both homogenous and mixed crosstalk. The values of PBOa and PBOb that maximized the bit rate of RT-based ADSL while maintaining spectral compatibility with the CO-based ADSL are set forth in Table 5. RT-based ADSL bit rates are in FIG. 9. FIG. 9 depicts the downstream bit rates of spectrally compatible downstream based RT-based ADSL via sloping power back-off.

TABLE 5

| | | | | RT-based | | CO-based | Basis | | |
|---|---|---|---|---|---|---|---|---|---|
| | | PBO | PBO at | ADSL | RT-based | ADSL | target | CO-based | Basis |
| | | at 138 | 1104 | down- | ADSL | down- | down- | ADSL | target |
| | | kHz | kHz | stream | upstream | steam | stream | upstream | upstream |
| | | PBOa | PBOb | bit rate | bit rate | bit rate | bit rate | bit rate | bit rate |
| Z-Y | Z | (db) | (db) | (kbps) | (kbps) | (kbps) | (kbps) | (kbps) | (kbps) |
| 0 | 9 | 35 | 0 | 12488 | 1456 | 5644 | 4850 | 705 | 645 |
| 1 | 10 | 23 | 53 | 8391 | 1456 | 4595 | 4595 | 624 | 553 |
| 2 | 11 | 31 | 53.4 | 5622 | 1425 | 3596 | 3595 | 522 | 461 |
| 3 | 12 | 48 | 31.2 | 4994 | 1417 | 2920 | 2920 | 554 | 344 |
| 4 | 13 | 58 | 17.9 | 3901 | 1351 | 2045 | 2045 | 453 | 202 |
| 5 | 14 | 53 | 0 | 4928 | 1264 | 1265 | 1265 | 343 | 163 |
| 6 | 15 | 48 | 0 | 4264 | 1171 | 702 | 705 | 207 | 124 |

The sloping power back-off methodology described above may be combined with the use of an improved notched PSD method. With no spectral shaping, DMT tones exhibit a relatively slow sin(x)/x roll-off and are susceptible to narrowband interference. It is generally accepted that some spectral shaping should be applied to get a sharper roll-off. Typical techniques involve using a window and cyclic prefix symbols to shape the roll-off into that of a raised cosine filter. The more excess bandwidth in the raised cosine filter the sharper the roll-off, but as the excess bandwidth becomes too high data tones have to be sacrificed and data rate is lost. While an excess bandwidth of 7.5% could be achieved by using all cyclic prefix tomes, a more realizable value of 6% excess bandwidth is assumed.

Assuming each tone has a 6% excess bandwidth raised cosine roll-off, the PSD of the entire DMT block may be calculated by summing the contribution from each tone's power. This is, however, a calculation intensive process so a simple but accurate approximation of the roll-off was created based on a number of test cases. Downstream RT-ADSL tomes between frequencies fa and fb are turned off and transmit no power. If fb≦fa then there is no notch. Otherwise, the model of the RT-based ADSL downstream PSD has the notch defined by the maximum of the “lower slope” and the “upper slope” in Table 6.

TABLE 6

| Frequency, f(Hz) | PSD (dBm/Hz) |
|---|---|
| f < fa | lower slope = −40 |
| fa ≦ f < fa + 12000 | lower slope = −40 − (1.167/1000)*(f − fa) |
| fa + 12000 ≦ f < fa + | lower slope = −54 − (0.2333/1000)*(f − fa − |
| 192000 | 12000) |
| fa + 192000 ≦ f | lower slope = −96 |
| f < fb − 192000 | upper slope = −96 |
| fb − 192000 ≦ f < fb − | upper slope = −54 − (0.2333/1000)*(fb − f − |
| 12000 | 12000) |
| fb − 12000 ≦ f < fb | upper slope = −40 − (1.167/1000)*(fb − f) |
| fb ≦ f | upper slope = −40 |

FIG. 10 depicts the model for the ADSL roll-off used in the present method in comparison to the sum of the power of the DMT tones with 6% raised cosine PSDs for the DMT tones turned off between fa=250 kHz and fb=700 kHz. This approach uses a sharper and deeper notch than the approach set forth above with no spectral shaping which assumed a 200 dB/decade slope. Again, if the upper notch frequency, fb, was calculated to be 1 MHz or greater then fb was set equal to 1000000 kHz, i.e., essentially infinity.

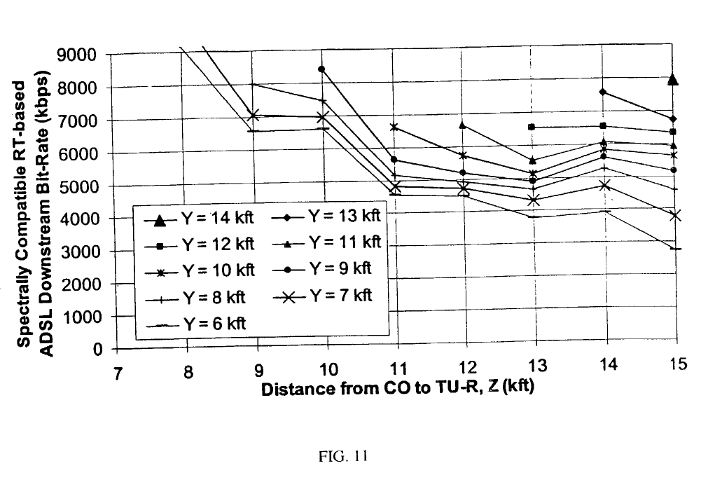

Using the notched PSD approach combined with sloping power back-off results were improved. In the simulation, the RT-based ADSL downstream transmit PSD is the SM9 PSD with a notch as defined in Table 6 and this PSD has the sloping PBO discussed above. All values of PBOa and PBOb from 0 to 60 dB in steps of 10 db were run, with all values of fa in steps of 50 kHz. For given values of PBOa, PBOb, and fa, the minimum value of upper notch frequency fb was found in which the RT-based ADSL was spectrally compatible with the CO-based basis ADSL. Then the downstream bit rate of the RT-based ADSL was calculated with the same crosstalk, but with −130 dBm/Hz background noise, and only frequencies at or below the lower notch frequency, fa, or at or above the upper notch frequency fb carry data. Both homogenous and mixed crosstalk compatibility tests must pass. The superior results of this combination method can be seen in Table 7 and FIG. 11.

TABLE 7

| | | | | RT- | RT- | | | | | | |
|---|---|---|---|---|---|---|---|---|---|---|---|
| | | | | based | based | RT-based | | CO-based | Basis | | |
| | | PBO | PBO at | ADSL | ADSL | ADSL | RT-based | ADSL | target | CO-based | Basis |
| | | at 138 | 1104 | lower | upper | down- | ADSL | down- | down- | ADSL | target |
| | | kHz | kHz | notch | notch | stream | upstream | steam | stream | upstream | upstream |
| | | PBOa | PBOb | freq. | freq. | bit rate | bit rate | bit rate | bit rate | bit rate | bit rate |
| Z-Y | Z | (db) | (db) | fa (kHz) | fb (kHz) | (kbps) | (kbps) | (kbps) | (kbps) | (kbps) | (kbps) |
| 1 | 10 | 40 | 40 | 900 | 915 | 7702 | 1456 | 4595 | 4595 | 624 | 553 |
| 2 | 11 | 30 | 50 | 450 | 569 | 5227 | 1425 | 3595 | 3595 | 522 | 461 |
| 3 | 12 | 50 | 20 | 600 | 719 | 5169 | 1417 | 2921 | 2920 | 554 | 344 |
| 4 | 13 | 50 | 0 | 450 | 641 | 4870 | 1351 | 2045 | 2045 | 453 | 202 |
| 5 | 14 | 40 | 0 | 450 | 555 | 5597 | 1264 | 1265 | 1265 | 343 | 163 |
| 6 | 15 | 30 | 0 | 300 | 469 | 5160 | 1171 | 707 | 705 | 207 | 124 |

Simulations were run and determined that all spectrally compatible RT-based ADSL PSD's are also compatible with all other basis systems, including HDSL2. Also, all spectrally compatible RT-based ADSL PSDs presented here passed the tests for spectral compatibility with G.lite.

Using a finer-grained search for the case of notched PSDs with PBO (i.e. finer than 10 db increments) would raise the bit rates somewhat further but at the cost of additional computation time. Knowledge of the loop lengths Y and Z are important as inaccurate loop length data would likely cause incompatibilities.

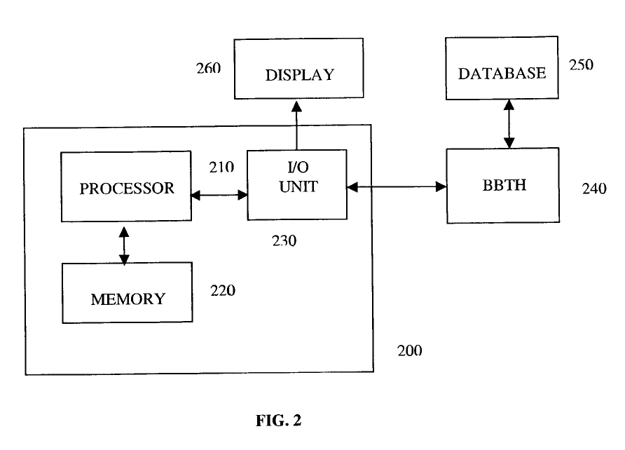

Referring to FIG. 2, an ADSL spectral compatibility system according to the present invention provides for a computer 200 having a processor 210 in communication with a memory 220 (which can comprise either primary memory, such as RAM, or secondary memory, such as a magnetic disk drive or other storage media or a combination thereof) and input/output (I/O) unit 230. I/O unit 230 is adapted to receive data indicative of the length of loop Z in kft and the distance from the CO to the AU-I, i.e. parameter Y also in kft from an external device such as a broadband test head (BBTH) 240 and/or a database 250 of network configuration data. Also, instead of using a BBTH, the data could be captured from an ADSL modem or DSLAM in the central office of the telephone network. Using this information and any additional information necessary regarding the gauge of the wire in the loop, the types and numbers of crosstalk disturbers, attenuation and transfer function of the loop sections and crosstalk coupling at all frequencies the optimal operating parameter for the RT-based ADSL terminal (ATU-I) is determined using the method set forth below which method is implemented in computer software stored in memory 220 and executed in processor 210. The information on optimal operating parameters to achieve maximum bandwidth and maintain spectral compatibility may then be used by the central office and its ATU-C in order to communicate with and modify the operation of the RT-based ADSL units. Display 260 may be used to display graphical and/or textual information related to the operation of the PSD measurements and crosstalk identification. Other input/output devices (not shown) may be used in conjunction with the computer 200 such as a keyboard, mouse, touchpad, trackball etc. in order to provide a user interface.

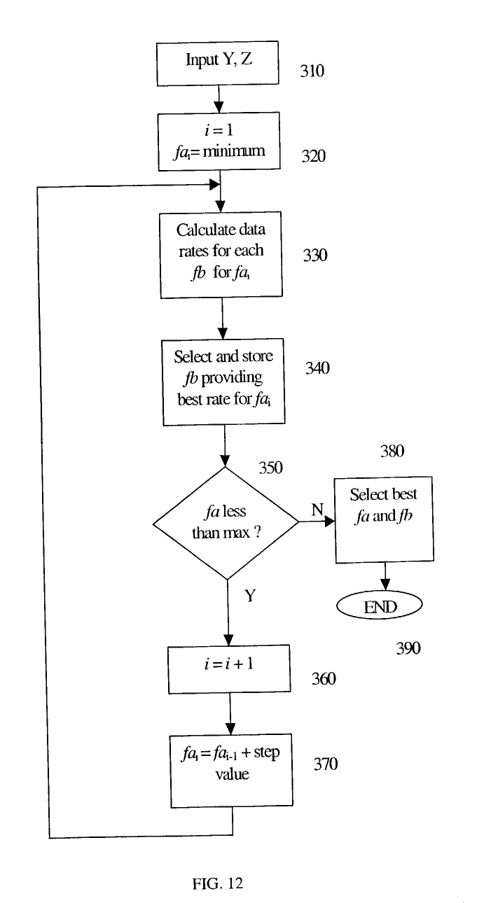

Processor 210 executes the method steps described herein as stored in memory 220 in order to determine the optimal operating parameters for the RT-ADSL while maintaining spectral compatibility. FIG. 12 depicts the flow of data and decisions necessary to implement the present methods in a system such as that described in FIG. 2. At the first step 100 of the process the distances, Z (kft), from the central office to the subscriber ATU-R and Y (kft) from the CO to the ATU-I are determined and input. This could be done through the use of a broadband test head (BBTH) 240, a device for the measurement of network characteristics that may be present in the central office, through the use of a database 250 that contains information on the topology of the local network, or by extracting this data from the DSL modems or DSLAMS. Once that information is known for a specific CO 110, ATU-I 120 and ATU-R 130 then the system can use one of the above described methods to determine optimal operating parameters.

The use of the notched PSD method is shown in FIG. 12, at step 320 an iteration counter is set and the lower frequency fa is set to a minimum possible value usually starting at a low frequency. At step 330 the process calculates the data rate that would be achieved for each of a range of upper notch frequencies fb for the given frequency fa while still maintaining spectral compatibility. At step 340 the upper notch frequency providing the best data rate while maintaining spectral compatibility is selected and stored for that value of fa. At step 350 the process determines of all of the possible lower notch frequency values have been processed. If not the iteration counter is incremented at step 360 and the lower notch frequency fa is incremented by a step value at step 370. A step value of 25 kHz is preferred but different step values may be used depending on the computational resources available and the time constraints on finding the data. At step 380 the upper and lower notch frequencies that provide the best data rate are selected and used by the ADSL system to transmit data. Alternatively, the process could save computational time by selecting the first upper notch frequency fb that provides a data rate within the spectral compatibility guidelines.

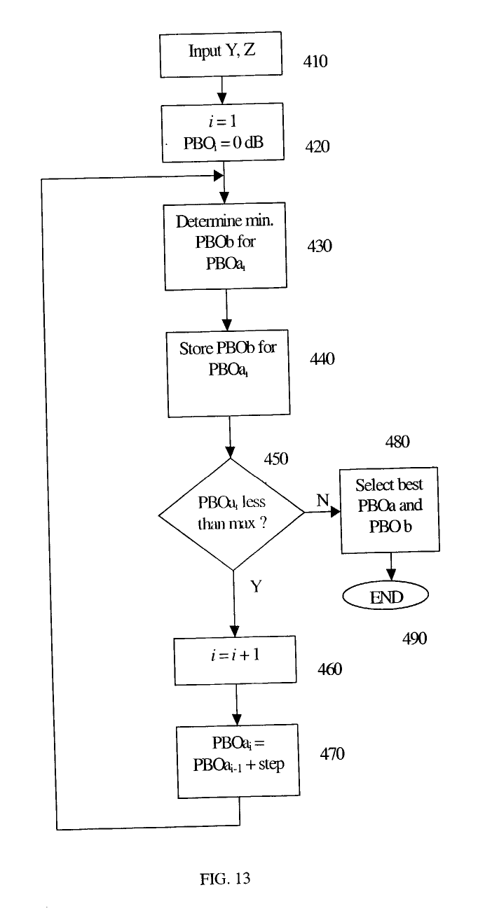

The notched PSD method set forth in FIG. 12 can be combined with flat power back-off and/or sloped power back-off. FIG. 13 depicts the data flow for the sloped power back-off (PBO) method of the present invention. Again the loop length Y and Z are necessary inputs to the calculations starting at step 410. An iteration counter is set at step 420 along with the minimum power back off for frequency a (138 kHz). It is possible to use various starting points for the beginning frequency. In the current system and method 138 kHz is used because it is the lowest downstream ADSL frequency in the current standard T1.413. The method requires a looping through of the values of PBOa from 0 to 60 db in steps, preferably of 1 dB, in order to find the minimum value of PBOb (at frequency b=1104 kHz) that achieved spectral compatibility with the CO-based ADSL with both homogenous and mixed crosstalk. To achieve this, at step 430 the data rates for the specified PBOa are measured for differing values of PBOb to find the lowest value of PBOb that achieves spectral compatibility. At step 440 the value of PBOb found for a given PBOa is stored. At step 450 the iterative process is terminated if all values of PBOa have been completed otherwise at step 460 the iteration counter is incremented and at step 470 the value of PBOa is incremented by a step value, preferably 1 db. Other step values may be used depending on the desire for computational efficiency. Once all values of PBOa have been completed, at step 480 the process selects the pair of PBOa and PBOb values that have provided the best data rate while remaining spectrally compatible. The values of PBOa and PBOb that maximized the bit rate of RT-based ADSL while maintaining spectral compatibility with the CO-based ADSL are selected for use by the ADSL system. The sloped power back-off method may be used alone or in conjunction with the notched PSD method.

The above calculations may be done in the digital signal line access multiplexer (DSLAM), in the ADSL modems (ATU-R, ATU-I or ATU-C) or performed off-line and stored. The actual place the calculations are done is not as important as the use of the spectral compatibility spectra by the RT-based ADSL.

The above description has been presented only to illustrate and describe the invention. It is not intended to be exhaustive or to limit the invention to any precise form disclosed. Many modifications and variations are possible in light of the above teaching. For example, the teachings may be applied to other types of xDSL systems. The applications described were chosen and described in order to best explain the principles of the invention and its practical application to enable others skilled in the art to best utilize the invention on various applications and with various modifications as are suited to the particular use contemplated.

We claim:

1. A method for maximizing the data transmission rates to a subscriber in a digital subscriber line (DSL) system while maintaining spectral compatibility between a CO-based DSL terminal and an RT-based DSL terminal comprising the steps of:
estimating the length or attenuation of the line between the CO-based DSL terminal and the RT-based DSL terminal and the length or attenuation of the CO-based DSL terminal and the subscriber;
determining the minimum power back-off at a predetermined upper frequency necessary to provide a spectrally compatible data transmission rate for each of a plurality of power back-off values at a predetermined lower frequency;
selecting the combination of power back-offs at the lower and upper frequencies that provides the greatest data transmission rate; and,
adjusting the downstream transmit power of each transmitted frequency tone of the RT-based DSL terminal between the lower and upper frequency by the amount of the slope between the power back-off for the lower frequency and the power back-off for the upper frequency.

2. The method of claim 1 wherein the plurality of power back-off values for the lower frequency varies.

3. The method of claim 1 wherein the predetermined upper frequency is approximately 1104 kHz.

4. The method of claim 1 wherein the predetermined lower frequency is approximately 138 kHz.

5. A method for maximizing the data transmission rates to a subscriber in a digital subscriber line (DSL) system while maintaining spectral compatibility between a CO-based DSL terminal and an RT-based DSL terminal comprising the steps of:
determining the length or attenuation of the line between the CO-based DSL terminal and the RT-based DSL terminal and the distance between the CO-based DSL terminal and the subscriber;
determining an upper notch frequency necessary to provide a spectrally compatible data transmission rate for each of a plurality of lower notch frequencies wherein data is not transmitted between the lower and upper notch frequencies;
selecting the lower and upper notch frequencies that provides the greatest data transmission rate while maintaining spectral compatibility for the measured distances; and,
transmitting data downstream from the RT-based DSL terminal below the lower notch frequency and above the upper notch frequency.

6. The method of claim 5 wherein each of the plurality of lower notch frequencies varies by approximately 25 kHz.

7. The method of claim 5 wherein the slope of the power of the transmitted signal is −200 dB/decade from the lower notch frequency.

8. The method of claim 5 wherein the slope of the power of the transmitted signal is +200 dB/decade toward the upper notch frequency.

9. The method of claim 5 wherein for upper notch frequencies greater than an upper threshold the upper notch frequency is set to 1,000,000 kHz.

10. The method of claim 9 wherein the upper threshold is approximately 1 MHz.

11. The method of claim 5 where in the slope of the transmitted power signal from the lower frequency fa to the upper frequency fb is adjusted from the unfiltered sin (x)/x roll-off by spectral shaping of the sharper roll-off by using windowing and/or filtering.

12. A system for the deployment of digital subscriber lines (DSL) to maintain spectral compatibility between a CO-based DSL terminal and an RT-based DSL terminal comprising:
means for determining the length or attenuation of the line between the CO-based DSL terminal and the RT-based DSL terminal and the distance between the CO-based DSL terminal and the subscriber;
means for determining the minimum power back-off at a predetermined upper frequency necessary to provide a spectrally compatible data transmission rate for each of a plurality of power back-off values at a predetermined lower frequency;
means for selecting the combination of power back-offs at the lower and upper frequencies that provides the greatest data transmission rate; and,
means for controlling the downstream transmit power of the RT-based DSL terminal between the lower and upper frequency by the amount of the slope between the power back-off for the lower frequency and the power back-off for the upper frequency.

13. The system of claim 12 wherein the predetermined upper frequency is approximately 1104 kHz.

14. The system of claim 12 wherein the predetermined lower frequency is approximately 138 kHz.

15. The system of claim 12 wherein the means for determining the minimum power back-off at the predetermined upper frequency determines such minimum power back-off for each of a plurality of power back off values for the predetermined lower frequency varying by 1 db.

16. A system for the deployment of digital subscriber lines (DSL) capable of maintaining spectral compatibility between a CO-based DSL terminal and an RT-based DSL terminal comprising:
means for determining the length or attenuation of the line between the CO-based DSL terminal and the RT-based DSL terminal and the distance between the CO-based DSL terminal and the subscriber;
means for determining an upper notch frequency necessary to provide a spectrally compatible data transmission rate for each of a plurality of lower notch frequencies wherein the data is not transmitted between the lower and upper notch frequencies;
means for selecting the lower and upper notch frequencies that provides the greatest data transmission rate while maintaining spectral compatibility for the measured distances; and,
means for controlling the transmittal of data downstream from the RT-based DSL terminal below the lower notch frequency and above the upper notch frequency.

17. The system of claim 16 wherein the means for determining determines the upper notch frequency for each of a plurality of lower notch frequencies varying by approximately 25 kHz.

18. The system of claim 16 wherein the slope of the power of the transmitted signal is controlled so as to be −200 dB/decade from the lower notch frequency.

19. The system of claim 16 wherein the slope of the power of the transmitted signal is controlled so as to be +200 dB/decade toward the upper notch frequency.

20. A method for maximizing the data transmission rates to a subscriber in a digital subscriber line (DSL) system while maintaining spectral compatibility between a CO-based DSL terminal and an RT-based DSL terminal comprising the steps of:
determining the adjustment to the power of each transmitted frequency tone necessary to provide the greatest data transmission rate while maintaining spectral compatibility; and,
storing the adjustments in memory for use by one ore more RT-DSL terminals.

21. The method of claim 20 wherein the step of determining the adjustment further comprises the steps of:
determining the minimum power back-off at a predetermined upper frequency necessary to provide a spectrally compatible data transmission rate for each of a plurality of power back-off values at a predetermined lower frequency; and,
selecting the combination of power back-offs at the lower and upper frequencies that provides the greatest data transmission rate.

22. The method of claim 20 wherein the step of determining the adjustment further comprises the steps of:
determining an upper notch frequency necessary to provide a spectrally compatible data transmission rate for each of a plurality of lower notch frequencies wherein data is not transmitted between the lower and upper notch frequencies; and,
selecting the lower and upper notch frequencies that provides the greatest data transmission rate while maintaining spectral compatibility for the measured distances.

23. The method of claim 20 further comprising the step of adjusting the downstream transmit power of each transmitted frequency tone of the RT-based DSL terminal based on the stored adjustment values.

24. An RT-based ADSL modem capable of transmitting a stream of data from a CO-based ADSL terminal to a subscriber as a plurality of frequency tones comprising:
means for adjusting to the power of each transmitted frequency tone necessary to provide the greatest data transmission rate while maintaining spectral compatibility with the CO-based ADSL based on stored adjustment criteria.

25. The modem of claim 24 further comprising:
means for determining adjustment criteria based on the minimum power back-off at a predetermined upper frequency necessary to provide a spectrally compatible data transmission rate for each of a plurality of power back-off values at a predetermined lower frequency; and,
means for storing the determined adjustment criteria.

26. The modem of claim 24 further comprising:
means for determining adjustment criteria based on an upper notch frequency necessary to provide a spectrally compatible data transmission rate for each of a plurality of lower notch frequencies wherein data is not transmitted between the lower and upper notch frequencies; and,
means for storing the determined adjustment criteria.

27. A CO-based ADSL modem capable of transmitting a stream of data to a subscriber through an RT-ADSL terminal as a plurality of frequency tones comprising:
means for determining the adjustment to the power of each transmitted frequency tone necessary to provide the greatest data transmission rate while maintaining spectral compatibility between the RT-ADSL and the CO-based ADSL;
means for communicating the adjustment to the RT-ADSL terminal.

28. The CO-based ADSL modem of claim 27 wherein the means for determining the adjustment criteria determines the minimum power back-off at a predetermined upper frequency necessary to provide a spectrally compatible data transmission rate for each of a plurality of power back-off values at a predetermined lower frequency.

29. The CO-based ADSL modem of claim 27 wherein the means for determining the adjustment criteria determines an upper notch frequency necessary to provide a spectrally compatible data transmission rate for each of a plurality of lower notch frequencies wherein data is not transmitted between the lower and upper notch frequencies.
